(19) United States
(12) Patent Application Publication
(10) Pub. No.: US 2006/0193221 A1
(43) Pub. Date: Aug. 31, 2006

(54) Optical head unit and optical disc apparatus

(76) Inventors: Sumitaka Maruyama, Yokohama-shi (JP); Kazuo Watabe, Yokohama-shi (JP)

Correspondence Address: Knobbe Martens Olson & Bear LLP;Intellectual Property Law, Fourteenth Floor, 2040 Main Street, Irvine, CA, 92614, US

(21) Appl. No.: 11/363,713

(22) Filed: Feb. 28, 2006

(30) Foreign Application Priority Data
Feb. 28, 2005 (JP) 2005-054926

(51) Int. Cl. G11B 7/00

(52) U.S. Cl. 369/44.41

(57) ABSTRACT

To provide an optical head unit and an optical disc apparatus which is configured to detect exactly the largeness of a focusing error when recording or reproducing information on/from an HD DVD specification optical disc, place a diffraction element having a diffraction pattern capable of providing an optical spot which mainly includes a radial direction component of a reflected laser beam reflected by an optical disc and difficult to generate a focusing error fluctuation, on the light-receiving surface of a photodetector which receives a reflected laser beam reflected on the recording layer of an optical disc, and outputs a corresponding signal.

### CROSS-REFERENCE TO RELATED APPLICATIONS

This application is based upon and claims the benefit of priority from prior Japanese Patent Application No. 2005-054926, filed Feb. 28, 2005, the entire contents of which are incorporated herein by reference.

### BACKGROUND

1. Field

The present invention relates to an information recording/reproduce apparatus/optical disc recording/reproduce apparatus which, records, reproduces and erases information on/from an optical disc capable of recording, reproducing and erasing information, by using a laser beam, and an optical pickup unit (optical head unit) used in the optical disc apparatus.

2. Description of the Related Art

An optical disc has been widely used as a recording medium suitable for recording, reproducing and erasing (recording repeatedly) information. Various optical discs of different specifications are proposed and used actually. According to the recording capacity, these optical discs are classified into CD and DVD specifications. According to the uses (data recording formats), the discs are sorted into a read-only type containing prerecorded information (called a ROM), a write once type capable of recording information only once (called a -R), and a rewritable type capable of recording and erasing information repeatedly (called a RAM or RW).

As the variety of specification and purpose of an optical disc has been increased, an optical disc recording/reproduce apparatus is required to be capable of recording reproducing and erasing on/from two or more specification optical discs. Further, an optical disc recording/reproduce apparatus is required to have the function to discriminate the specification of an optical disc set in the apparatus as an essential condition, even if the recording and erasing of information are difficult.

Therefore, an optical pickup incorporated in an optical disc information recording/reproduce apparatus must be able to obtain a reflected light from at least track or record mark string specific to an optical disc, regardless of the disc specifications DVD/CD and types ROM/RAM/RW, and control tracking and focus of at least an objective lens and an optical pickup holding an optical pickup.

It is disclosed by, for example, Japanese Patent Application Publication (KOKAI) No. 2004-39165 discloses a method of obtaining a good tracking error signal by dividing a reflected light from an optical information recording medium (optical disc) into a portion where a 0th-order light and ±1st-order diffraction light are overlapped and a portion where they are not overlapped, applying a reflected light to an independent optical detection means, and obtaining a designated signal.

However, in the unit disclosed by the above document, a diffraction angle of the ±1st-order diffraction light of the reflected light from the optical information recording medium is different depending on a wavelength of the reflected light, a track pitch of the optical information recording medium, etc.

Therefore, in an optical pickup unit which receives reflected light with more than one wavelength or a reflected light from track pitches of several types of optical information recording medium, it is impossible to uniquely determine a portion where a 0th-order light and ±1st-order diffraction light are overlapped and a portion where they are not overlapped.

Further, in the method disclosed by the above document, when a track pitch is different in a track of L/G structure consisting of a land and a groove, a track cross signal leaks into a focus signal and makes the focusing difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

The file of this patent contains at least one drawing executed in color. Copies of this patent with color drawings will be provided by the Patent and Trademark Office upon request and payment of the necessary fee.

FIG. 1 is an exemplary diagram showing an example of the configuration of an information recording/reproduce apparatus (optical disc apparatus) according to a first embodiment of the invention;

FIG. 2A is an exemplary diagram showing an example of a pattern of dividing a luminous flux by a hologram used in an optical head of the optical disc apparatus shown in FIG. 1, and a pattern of a light-receiving area of a photodiode according to a first embodiment of the invention;

FIG. 2B is an exemplary diagram showing an example for explaining a dividing pattern of the hologram used in the optical head of the optical disc apparatus shown in FIG. 2A according to a first embodiment of the invention;

FIG. 3 is an exemplary showing an example of the output of a focus detection light-receiving area of the photodiode used in the optical head of the optical disc apparatus shown in FIG. 1 according to a first embodiment of the invention;

FIGS. 4A and 4B are exemplary diagrams showing examples of the overlap of 0th-order light and ±1st-order light of a laser beam diffracted by a groove (recess) or a land (other than a recess) on the recording surface of an optical disc according to a first embodiment of the invention;

FIG. 5 is an exemplary diagram showing an example of the overlap of a 0th-order light and ±1st-order light of a laser beam diffracted by a groove (recess) or a land (other than a recess) of the recording surface of an optical disc according to a first embodiment of the invention;

FIGS. 6A to 6F are exemplary photographs of the outputs simulating the distribution of the intensity of a reflected laser beam for explaining the influence of the cycles of a land and a groove on a focusing error signal according to the first embodiment of the invention;

FIG. 7 is an exemplary graph explaining the relationship between the wavelength and diffraction efficiency (blaze type) of a laser beam, when the diffraction grating in the graph of FIG. 4 showing the relation of the amount of defocus to the strength of a laser beam passing a focus detection light-receiving area of a photodiode used in an optical head is applied to the optical disc apparatus shown in FIG. 5 according to the first embodiment of the invention;

FIG. 8 is an exemplary graph showing an example of the output when the focusing error detection range (defocus range) of a focus detection light-receiving area of a photodiode used in an optical head according to the first embodiment of the invention;

FIG. 9 is an exemplary graph showing the results of detection of a focusing error in a ultra-high density next generation DVD, in the optical head shown in FIG. 1 according to the first embodiment of the invention;

FIG. 10 is an exemplary diagram showing another embodiment of the hologram pattern shown in FIG. 2 according to the first embodiment of the invention;

FIG. 11 is an exemplary diagram showing still another embodiment of the hologram pattern shown in FIG. 2 according to the first embodiment of the invention; and

FIG. 12 is an exemplary diagram showing a further embodiment of the hologram pattern shown in FIG. 2 according to the first embodiment of the invention.

### DETAILED DESCRIPTION

Various embodiments according to the invention will be described hereinafter with reference to the accompanying drawings. In general, according to one embodiment of the invention, an optical head unit and an optical disc apparatus which is configured to detect exactly the largeness of a focusing error when recording or reproducing information on/from an HD DVD specification optical disc, place a diffraction element having a diffraction pattern capable of providing an optical spot which mainly includes a radial direction component of a reflected laser beam reflected by an optical disc and difficult to generate a focusing error fluctuation, on the light-receiving surface of a photodetector which receives a reflected laser beam reflected on the recording layer of an optical disc, and outputs a corresponding signal.

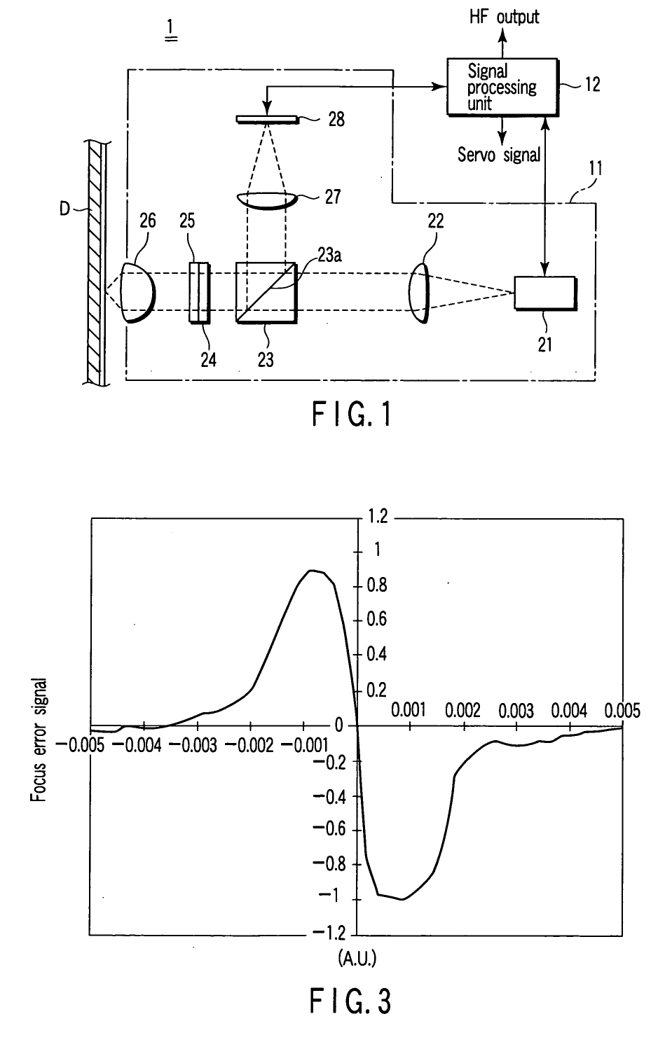

According to an embodiment, FIG. 1 shows an optical disc apparatus to which the embodiments of the invention are applicable.

An optical disc apparatus 1 shown in FIG. 1 includes an optical pickup unit (an optical head unit) 11 which can record information in a recording medium (an optical disc) D, read information recorded on an optical disc, and erase information recorded on an optical disc. The optical head unit 11 also includes a signal processing unit 12 to reproduce information recorded on an optical disc from an optical beam detected by the operation of the optical head unit 11 and an optical head unit, and though not shown, mechanical elements, such as, a head moving mechanism to move an optical head unit along the recording surface of an optical disc D, and a disc motor to rotate an optical disc at a specified speed.

The optical head unit 11 includes a light source, or a laser diode (LD) 21 that is a semiconductor laser element, for example. The wavelength of a laser beam emitted from the LD (light source) 21 is 400-410 nm, preferably, 405 nm.

A laser beam from the LD (light source) 21 is collimated (to be a parallel beam) by a collimator lens 22, passed through a polarization beam splitter (PBS) 23, an optical dividing element or a hologram plate (hologram plate) 24 and ¼ wavelength plate (a polarization control element) 25, and given a fixed convergence by an objective lens (OL) 26. The objective lens 26 is made of plastic, and has a numerical aperture (NA) of 0.65, for example.

The laser beam given the fixed convergence by the objective lens 26 is passed through a not-described cover layer of an optical disc, and condensed on the recording layer or close to there (The laser beam from the light source 21 provides a smallest optical spot at the focal position of the objective lens 26.)

Though not described in detail, the smallest optical spot of a laser beam is condensed on the recording layer of the optical disc D by moving the objective lens 26 (optical head unit 11) in the direction (optical axis direction) orthogonal to the recording surface by a known focus control, so that the distance from the objective lens 26 to the recording surface of the optical disc D becomes identical to the focal distance of the objective lens 26.

A laser beam reflected on the information recording surface of the optical disc D is captured and converted by the objective lens 26 to have a substantially parallel sectional beam shape, and returned to the polarization beam splitter 23.

The reflected laser beam returned to the polarization beam splitter 23 passes through a ¼ wavelength plate 25, and reflected on a polarizing surface 23a of the polarization beam splitter 23, because the polarizing direction of the laser beam advancing to the optical disc D is rotated by 90°.

The laser beam reflected by the polarization beam splitter 23 is focused as an image on the light-receiving surface of a photodiode (photodetector) 28 through a focusing lens 27.

The reflected laser beam is divided into a specified shape and number of portions to meet the arrangement of detection areas (light-receiving areas) and shape formed on the light-receiving surface of a photodetector 28 provided in a later stage, when passing through the hologram plate 24.

The light-receiving part of the photodetector 28 is usually divided into several light-receiving (detection) areas (detection), and outputs a current corresponding to the intensity of light from each light-receiving areas.

The current outputted from each light-receiving area is converted into a voltage by a not-shown I/V amplifier, and processed by a signal processing unit 12 to be usable for a HF (reproduce) signal, a focusing error signal and a tracking error signal. Thought not described in detail, the HF signal is converted into a specified signal format, and output to a temporary storage or an external storage through a specified interface.

The signal obtained from the signal processing unit 12 is used also for a servo signal for moving the objective lens 26 in the direction (optical axis direction) orthogonal to the surface including the recording surface of an optical disc, so that the distance from the objective lens 26 to the recording surface of the optical disc D becomes identical to the focal distance of the objective lens 26, and in the direction orthogonal to the extending direction of the track or record mark (string) formed on the recording surface of an optical disc.

A servo signal is generated based on a tracking error signal indicating a change in the position of the objective lens 26 and a known method of detecting a track error (error), so that an optical spot having a specified size at the focal position of the objective lens 26 becomes the specified size on the recording layer of the optical disc 1 according to a known focusing error (error) detection method, and the optical spot is guided at substantially the center of the recording mark string or track according to a known track error (error) detection method.

Namely, the objective lens 26 is controlled, so that a smallest optical spot condensed by the objective lens 26 can be provided at substantially the center of the track or record mark string formed on the not-shown recording layer of the optical disc D in its focal distance.

More particularly, a laser beam L emitted from the semiconductor laser (LD) 21 is collimated by the collimator lens 22. The laser beam L is a linearly polarized light, passed through (polarization beam splitter 23 and hologram plate) 24, changed (rotated) in the polarizing surface to a circularly polarized light by the ¼ wavelength plate 25, given a fixed convergence when passed through the objective lens 26, and condensed on the recording surface of the optical disc D.

The laser beam L condensed on the recording surface of the optical disc D is optically modulated by (being reflected or diffracted by) the record mark, for example, a pit (or a pit string) and a mark (a pattern with different reflectivity) recorded on the recording surface, or a groove formed on the recording surface of an optical disc.

The laser beam reflected or diffracted on the recording surface of an optical disc is substantially paralleled again by the objective lens 26, and passed again through the ¼ wavelength plate 25, and returned to the hologram diffraction element (hologram plate) 24, with the polarizing direction changed by 90° from an advancing path.

The hologram element 24 has a polarizing pattern that is acted only to the polarized light (reflected laser beam) in a returning path, divides the reflected laser beam into several luminous flux, and deflections it in a specified direction (changes the distance from the center toward the light-receiving area of a photodetector provided for each laser beam, for each divided laser beam).

As described above, the polarizing direction is changed 90° from the advancing path, and the reflected laser beams divided into a specified number are reflected on the polarizing surface of polarization beam splitter 23, and condensed in the respective light-receiving areas (described later) of the photodetector 28 through the focusing lens 27.

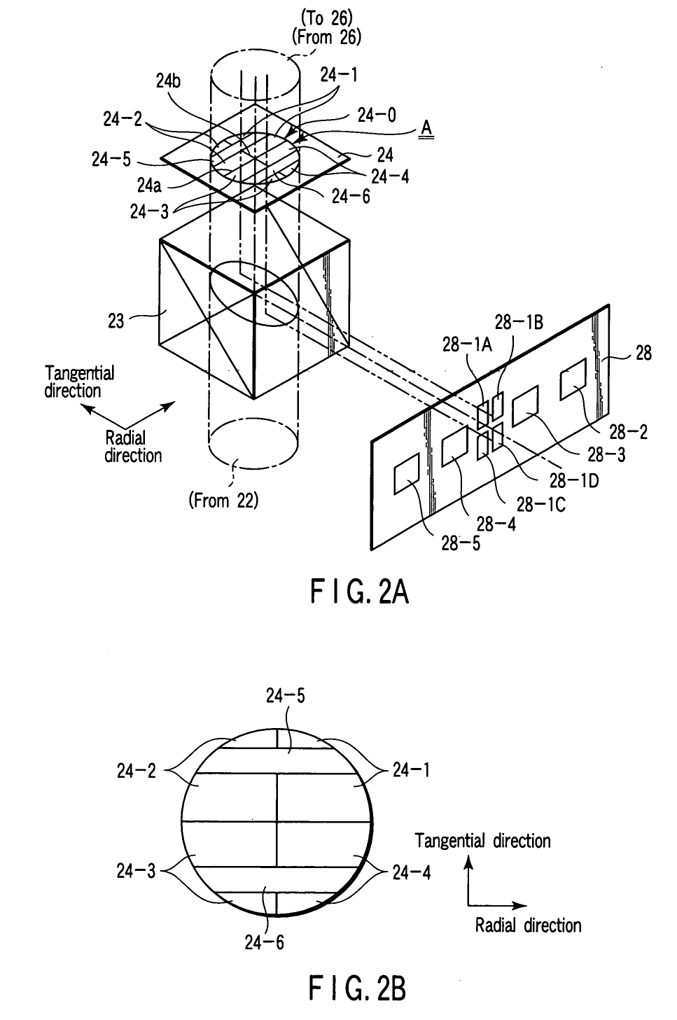

FIG. 2A is a schematic diagram showing an example of a pattern of dividing a luminous flux by a hologram incorporated in an optical head of the optical disc apparatus shown in FIG. 1, and a characteristic (pattern) of arrangement and shape of a light-receiving area of a photodiode (photodetector). FIG. 2B is shows an example of a pattern given to the hologram shown in FIG. 2A.

As shown in FIG. 2A and FIG. 2B, the hologram plate 24 has a substantially circular pattern 24-0. The pattern 24-0 is separated by a boundary line 24a passing almost the center and a boundary line 24b orthogonal to the boundary line 24a, and has first to fourth areas 24-1 to 24-4 defined parallel to the boundary line 24a, and has two elongated areas 24-5 and 24-6 in the radial direction defined parallel to the boundary line 24a and at a position of fixed distance to the boundary line 24a, among these first to fourth areas. The boundary line 24a is extended in the radial direction orthogonal to the direction (tangential direction) of a not-shown track (guide groove) formed previously concentrically or spirally to the recording surface of an optical disc.

Namely, the hologram dividing pattern shown in FIG. 2B is used to obtain a focusing error signal by using the detection areas 24-5 and 24-6 secured linearly against the radial direction of an optical disc.

The dividing patterns 24-1 to 24-4 are the areas to obtain a tracking signal. Laser beams passing through these areas are diffracted to different angles.

The patterns 24-1 to 24-4 (two airs parallel to the boundary line 24a) are formed to be capable of focusing the laser beams passing through the patterns as an image in the detection (light-receiving) areas 28-2 to 28-5 of the photodetector 28. The laser beam passing through the pattern 24-1 forms an image in the detection area 28-2. Likewise, the beam passing through the pattern 24-2 forms an image in the area 28-5, the beam passing through the pattern 24-3 forms an image in the area 28-4, and the beam passing through the pattern 24-4 forms an image in the area 28-3.

Therefore, if the intensities of signals generated in the light-receiving areas 28-2 to 28-5 are assumed to be P28-2 to P28-5, a push-pull signal can be obtained by the equation
(P28-2+P28-3)−(P28-4+P28-5) (1)

A tracking error signal can be obtained by a phase difference detection method (DPD method) by the equation
Ph(P28-2+P28-4)−Ph(P28-3+P28-5) (2)

The laser beams passing the patterns for detecting a focusing error are formed to be able to form an image in substantially central areas 28-1A to 28-1D of the tracking error detection area.

Namely, the laser beams passing through the areas 24-5 and 24-6 are condensed between the detection areas 28-1A and 28-1B, and between the areas 28-1C and 28-1D, respectively, for example. This method provides a focus detection system called a known double knife edge method. Of course, a known knife edge method using one of the diffraction patterns 24-5 and 24-6 for detection of a focusing error and using two detection areas of a photodetector is also usable.

If the intensities of signals generated in the light-receiving areas 28-1A to 28-1D are assumed to be P28-1A to P28-1D, a focusing error signal with the output changed according to the amount of defocus (deviation from a focal position) of the objective lens 26 can be obtained by the equation
(P28-1A+P28-1D)−(P28-1B+P28-1C) (3)

This focusing error signal is as known well shows the S-shaped characteristic, that is, the output polarity is inverted when the distance from the objective lens 26 to the recording layer of the optical disc 27 is shorter than the position (focal position) where the optical spot given to a laser beam by the objective lens 26 is smallest (the objective lens 26 is close to an optical disc) and when that distance is longer than the focal position (the smallest spot position or the objective lens 26 is far from an optical disc.)

Namely, when the optical spot of the optical disc D is defocused (separated from the minimum beam spot position), the optical spot formed in each detection area of a photodetector is also defocused (the optical spot becomes large.)

For example, the “+” side peak of the S-shaped characteristic shown in FIG. 3 shows that most laser beams passing through the area 24-5 of the hologram element 24 form an image in the detection area 28-1A, and most laser beams passing through the area 24-6 form an image in the detection area 28-1D.

Likewise, the “−” side peak of the S-shaped characteristic shows that most laser beams passing through the areas 24-5 and 23-6 form an image in the detection areas 28-1B and 28-1C.

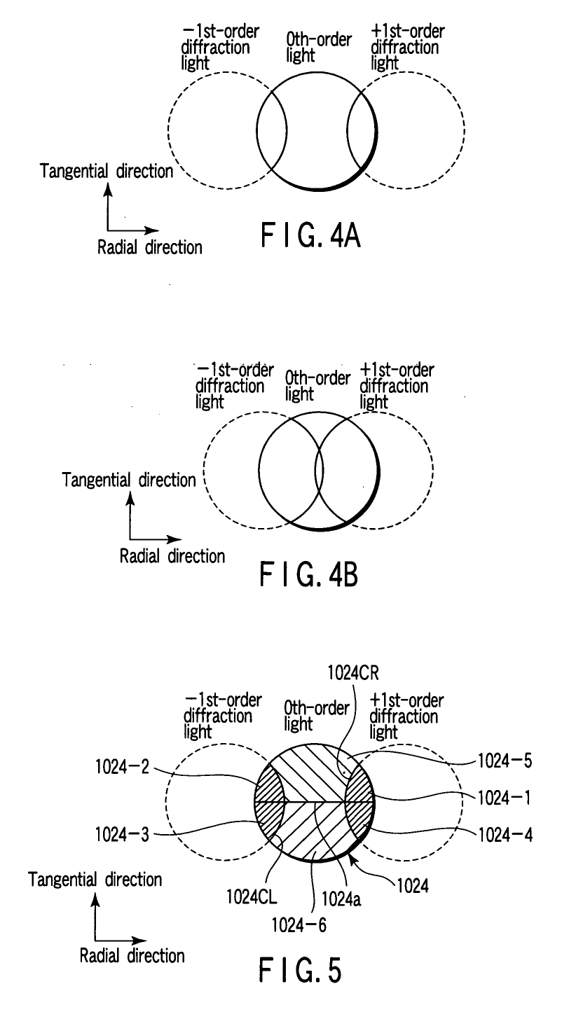

FIG. 4A and FIG. 4B show the overlap of 0th-order light and ±1st-order diffraction light of a laser beam diffracted by a track or a groove (recess) or a land (other than a groove) on the recording surface of the optical disc D.

For example, when an optical disc is a read-only disc or write once disc, information is recorded in a groove or land. The width of land or groove not used for recording (a record mark is not formed) is narrow compare with a groove and land used for recording. Thus, the diffraction angle of ±1st-order diffraction light is large and the overlap of optical beam spots as shown in FIG. 4A is generated.

Conversely, when an optical disc is a rewritable disc, information is recorded in both groove and land in order to increase the recording density. Therefore, unlike a read-only or recordable disc, the widths of land and groove are the same (wide compared with a land or groove of a read-only or recordable disc not used for recording information). As a result, a track cycle is large and the diffraction angle of ±1st-order diffraction light is narrow compared with a read-only or recordable disc. Therefore, as shown in FIG. 4B, the overlap area where a diffraction light (±1st-order diffraction light) diffracted by a land and groove a 0th-order light (non-diffracted light) lies over a 0th-order light, becomes large. This means that the influence on the focus is increased.

Based on the overlap of the laser beam shown in FIG. 4A and FIG. 4B, a hologram given a common circular conventional diffraction pattern shown in FIG. 5. In the common hologram shown in FIG. 5, a circular pattern 1024 divided in a tangential direction by a boundary line 1024a passing through almost the center is divided into a set of areas 1024-1, 1024-5, 1024-2 and a set of areas 1024-2, 1024-6, 1024-4. Patterns 1024-1 and 1024-4 are divided by a boundary line 1024CR at a position where a (+)1st-order diffraction light is laid over the circular pattern 1024. Likewise, patterns 1024-2 and 1024-3 are divided by a boundary line 1024CL at a position where a (−) 1st-order diffraction light is laid over the circular pattern 1024. However, if the pattern as shown in FIG. 5 is used, focusing is difficult because a track cross signal leaks in, as explained later, when obtaining a focus signal by using a laser beam diffracted by the pattern 1024-5 or 1024-6 for reproducing information from several types of optical disc of the L/G structure consisting of a flat part (land) and a groove with a different pitch.

Now, explanation will be given on how a focusing error signal is influenced by a cycle of land and groove.

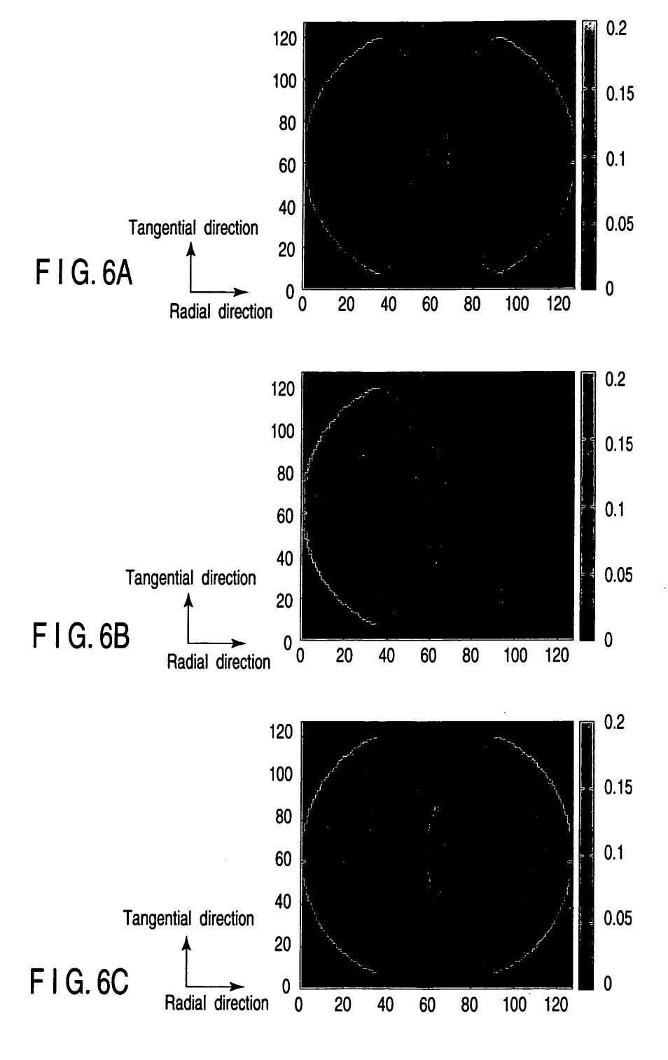

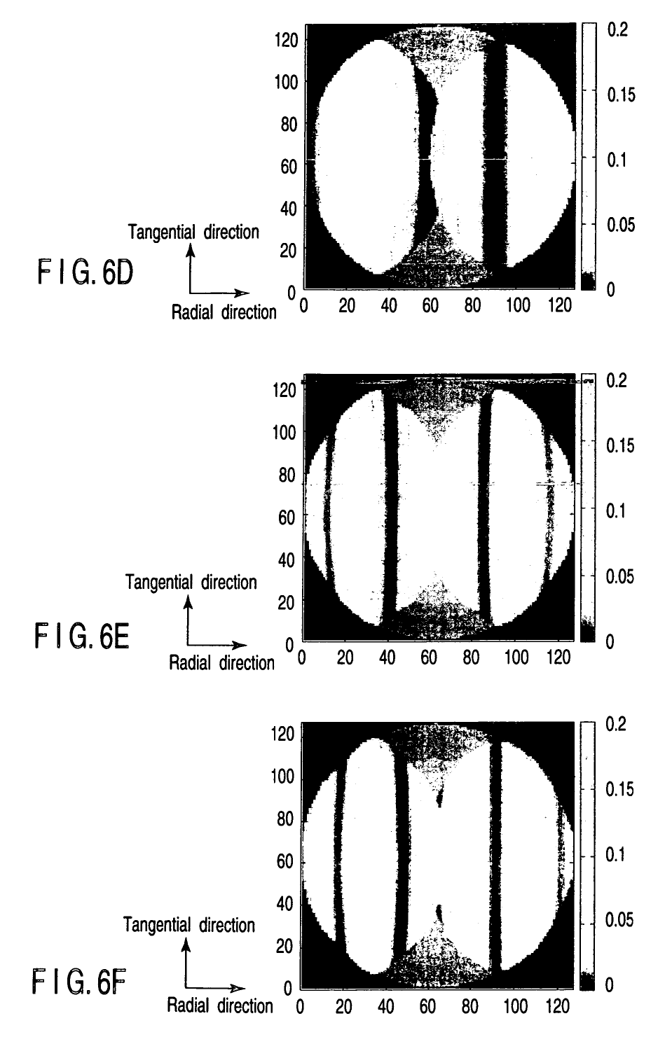

FIG. 6A to FIG. 6F show the results of calculation (simulation) of the intensity distribution of a reflected laser beam reflected or diffracted after being condensed on the recording surface of an optical disc, an HD DVD rewritable optical disc, assuming that a track pitch Tp is 0.34 μm, a recording/reproduce laser beam wavelength λ is 405 nm and a number of aperture of an objective lens NA is 0.65.

FIG. 6A and FIG. 6B show the intensity distribution when an optical spot condensing position is on the recording surface of an optical disc, that is, the amount of defocus is 0 μm (on just focus). FIG. 6A shows the intensity distribution when an optical spot is at the center of a groove or land. FIG. 6B shows the intensity distribution when an optical spot is at a position between a groove and a land.

FIG. 6C and FIG. 6D show the intensity distribution when an optical spot condensing position is at a position of 1.0 μm from the recording surface, that is, the amount of defocus is 1.0 μm. FIG. 6C shows the intensity distribution when an optical spot is at the center of a groove or land. FIG. 6D shows the intensity distribution when an optical spot is at a position between a groove and a land.

FIG. 6E and FIG. 6F show the intensity distribution when an optical spot condensing position is at a position of 2.0 μm from the recording surface, that is, the amount of defocus is 2.0 μm. FIG. 6E shows the intensity distribution when an optical spot is at the center of a groove or land. FIG. 6F shows the intensity distribution when an optical spot is at a position between a groove and a land.

When the amount of defocus is 0 as in FIG. 6A and FIG. 6B, a push-pull operation is take place. The intensity is differentially changed according to whether the whole area with the overlapped 0th-order light and ±1st-order diffraction light is in the radial direction of optical spot, that is, according to the positions of an optical spot for a land and groove.

Contrarily, when the amount of defocus becomes 1.0 μm as in FIG. 6C and FIG. 6D, an interference fringe appears in the area where an 0th-order light and ±1st-order light are overlapped, and an intensity distribution occurs in a radial direction. Further, according to the position of an optical spot, an interval of an interference fringe is unchanged, but a peak of an interference fringe is moved in a radial direction.

When the amount of defocus becomes 2.0 μm as in FIG. 6E and FIG. 6F, the amount of defocus becomes similar to the case of 1.0 μm, and an interference fringe appears in the area where a 0th-order light and ±1st-order light are overlapped. In this case, an interval (pitch) of an interference fringe becomes a half of the case that the amount of defocus is 1.0 μm.

As explained above, when a reflected or diffracted laser beam with a changing intensity distribution is divided by a hologram having the dividing pattern as shown in FIG. 2, an area with the overlapped 0th-order light and ±1st-order diffraction light comes in the patterns 24-5 and 24-6 used for generating a focusing error signal.

Therefore, the intensity of a laser beam passing through the areas 24-5 and 24-6 for a focusing error signal is fluctuated when an optical spot crosses a land and groove (track crossing). As the interval of an interference fringe generated in the area that a 0th-order light and ±1st-order light are overlapped is changed depending on the change in the amount of defocus, a fluctuation amount (laser beam intensity) depends on the amount of defocus.

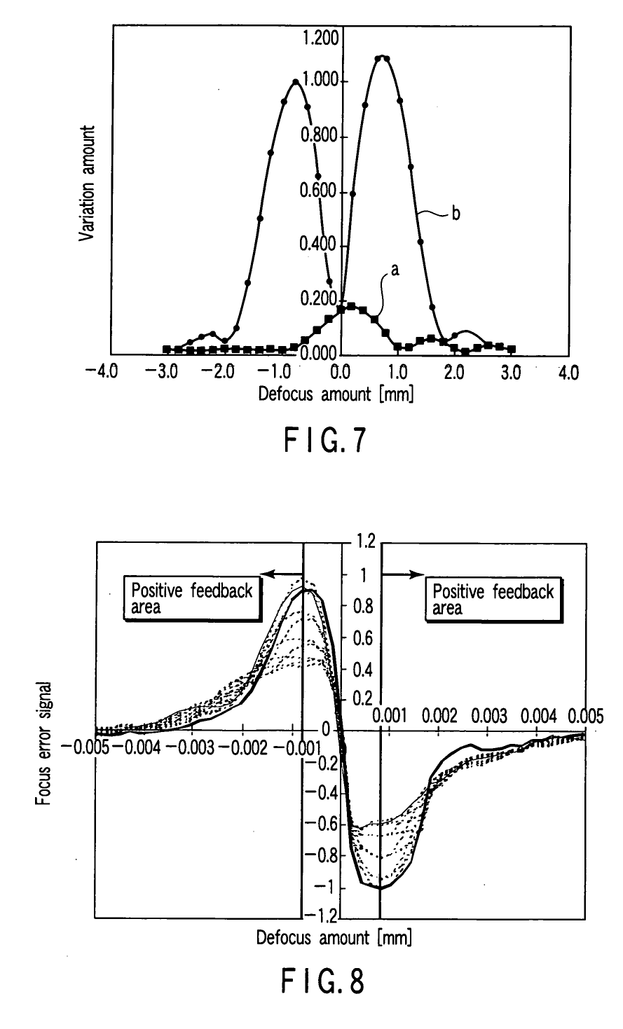

The fluctuation is calculated and graphically shown by the curve b in FIG. 7. In FIG. 7, the horizontal axis indicates the amount of defocus, and the vertical axis indicates a fluctuation amount of a focusing error signal.

The curve b in FIG. 7 concerns a common optical head (e.g., using the diffraction pattern as shown in FIG. 5). When the amount of defocus is 1 μm or −1 μm, the fluctuation amount (of a focusing error signal) reaches a peak. Usually, when starting the focus servo, move an objective lens forcibly from the recording surface of an optical disc, and then move it close thereto, thereby detecting a focus.

As a condensing position of an optical spot comes close to the recording surface of an optical disc, the S-shaped characteristic as indicated by the solid line in FIG. 8 is detected and the coming into a positive feedback area is detected. If the focus serve is turned on after passing the positive feedback area and before going into a positive feedback area of the opposite side, a condensing position of an optical spot comes close to the recording surface of an optical disc and the focus serve is effected. Namely, the distance from an objective lens to an optical disc becomes identical to a position where an optical spot defined at a focal position of an objective lens becomes smallest.

In the case that a fluctuation is generated as indicated by the curve b in FIG. 7 (a common optical head [e.g., when using the diffraction pattern as shown in FIG. 5]), when the peak of fluctuation is close to the peak of a focusing error signal, an output focusing error signal is largely fluctuated even if the position of an objective lens is the same, as shown in FIG. 8. In FIG. 8, the horizontal axis indicates the amount of defocus, and a focusing error signal influenced by the fluctuation of defocus amount is indicated by several broken lines. Each broken line in FIG. 8 indicates a focusing error signal from an area having a track, when an optical spot is moved by 2 tracks toward the radial direction from the position where the result indicated by the solid line is obtained.

Namely, it is seen from FIG. 8 that even if the amount of defocus is substantially the same, the level of a focusing error signal is fluctuated according to the position on an optical disk traced (radiated) by an optical spot (whether the position is influenced by the diffraction by a track).

Generally, as the tracking operation (control) is off when effecting focus control based on a focusing error signal, the position of an optical spot to a track is considered equivalent to indefinite (not fixed). Therefore, as far as using a common hologram using the overlap of a non-diffracted light (0th-order light) and ±1st-order diffraction light as a boundary, the above-mentioned fluctuation is unavoidable.

As explained from the equation (3), when the amount of defocus is 0 μm, the fluctuation cancels each other, and the fluctuation of a focusing error signal is decreased, but the influence of fluctuation is likely to occur near the peak of a focusing error signal. Namely when the fluctuation of a focusing error signal occurs at the peak of focusing error, a problem for example the failure in starting focus servo occurs as explained before.

In other words, a focusing error signal from the position where a track (land/groove) of the optical disc D exists is greatly fluctuated in the largeness as indicated by the broken line in FIG. 8, and a positive feedback area may not be exactly detected. When the fluctuation of a focusing error signal is increased further, no focusing error signal may not be obtained.

It is seen from FIG. 6A to FIG. 6F that a change in the pitch of an interference fringe is caused by the land/groove structure of an optical disc and an interference fringe is generated in the direction parallel to the tangential direction. An interference fringe is moved in the radial direction, when the position on an optical disc traced (radiated) by an optical spot is changed.

Therefore, to prevent the influence of the movement of an interference fringe on the intensity of a focusing error signal, a hologram pattern may be divided so that the amount of light is always almost constant in the hologram area from which a focusing error signal is obtained. Namely, use an area having a linear width in the radial direction as an area for calculation of a focusing error signal.

The curve a in FIG. 7 shows how the sum signal of a focusing error signal fluctuates when defocus occurs while an optical beam (spot) is scanning (moving) toward a track, in the above-mentioned condition, compared with the curve b (for example, when using the diffraction pattern as shown in FIG. 5). The signal indicated by the curve a in FIG. 7 uses a hologram element having a hologram plate pattern extending linearly in the radial direction as shown in FIG. 2 in the optical head unit of the optical disc apparatus shown in FIG. 1.

Referring to FIG. 7 again, when a hologram element having the pattern shown in FIG. 2 is used, the fluctuation of a focusing error signal when an optical spot is scanned toward a track is decreased sufficiently in the largeness (absolute value) and defocus reaches a peak near 0 μm, as indicated by the curve a. This is explained by that the fluctuation of a focusing error signal is decreased by the cancellation of fluctuation as indicated by the curve a in FIG. 7.

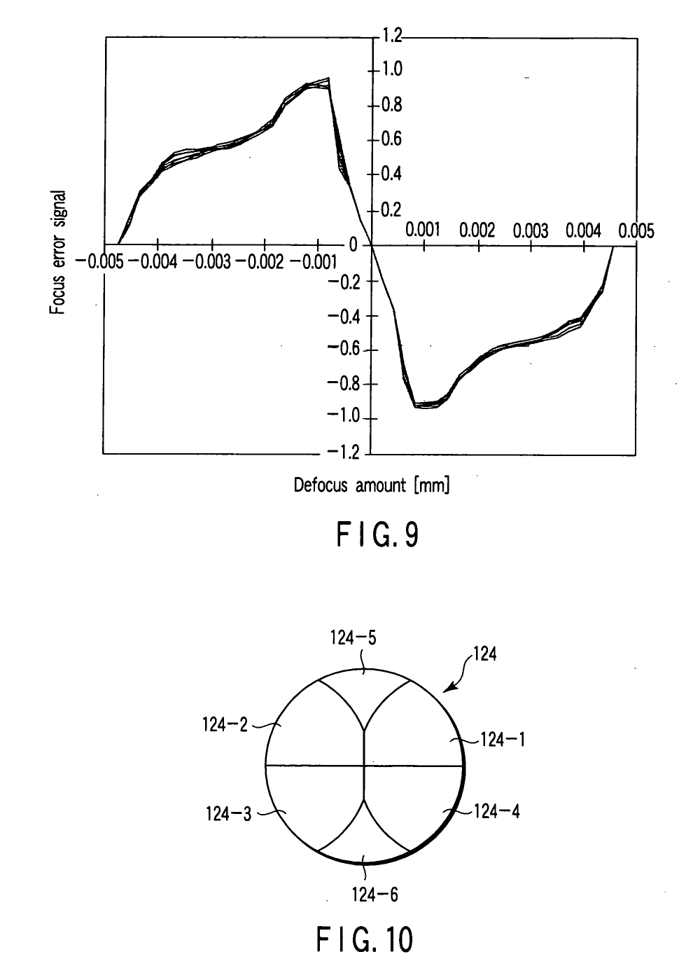

FIG. 9 shows a focus detection range when a hologram having a common pattern as shown in FIG. 5 is used in the optical disc apparatus shown in FIG. 2, and an HD DVD specification disc is reproduced.

As seen from FIG. 9, since the distance from a peak to a peak of a focus difference signal cannot be taken wide in an HD DVD specification disc unlike in a current DVD or CD specification optical disc, a peak of a focus difference signal exists near ±1 μm. In this case, as indicated by the curve b in FIG. 7, the peak may be identical to the peak of the fluctuation of a focusing error signal obtained by using a current common optical head (hologram diffraction pattern). Therefore, the detection system using the areas 24-5 and 24-6 ensured linearly against the radial direction as shown in FIG. 2 is very useful.

In other words, when a hologram pattern shown in FIG. 2 is used, the largeness (absolute value) of a focusing error signal is substantially not fluctuated by the influence of diffraction of a laser beam. Namely by using the hologram pattern of FIG. 2, the largeness of a focusing error signal is fluctuated little regardless of the position of an optical spot in a land/groove, and a suitable focusing error signal is obtained. This achieves stable focusing for an HD DVD specification optical disc.

FIG. 10 shows another embodiment of the hologram pattern shown in FIG. 2.

n FIG. 10, the dividing patterns 124-5 and 124-6 used for generating a focusing error signal (100 is added to the same reference numerals to discriminate from FIG. 2) are formed in the areas except the areas passing the ±1st-order diffraction light of a rewritable disc explained in FIG. 4B.

Namely, by using the hologram pattern shown in FIG. 10, a focusing error signal can be obtained without influence of a diffraction light caused by the track (land/groove) structure.

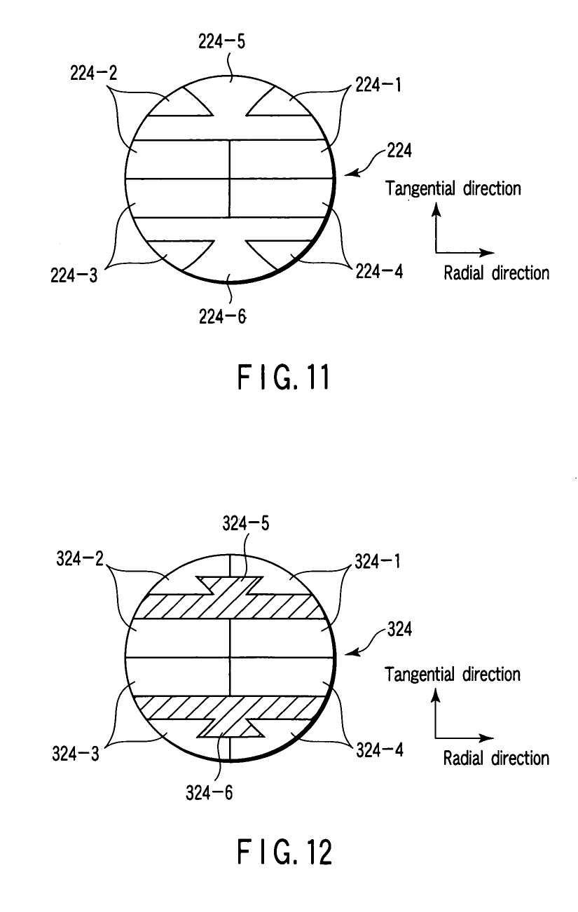

FIG. 11 and FIG. 12 show a still another embodiment of the hologram pattern shown in FIG. 2.

In FIG. 11, the dividing patterns 224-5 and 224-6 used for generating a focusing error signal (200 is added to the same reference numerals to discriminate from FIG. 2) are formed by overlapping the areas except (excluding) the areas passing the ±1st-order diffraction light of a rewritable disc explained in FIG. 4B with the linear detection area extending in the radial direction shown in FIG. 2. By overlapping the areas except the areas passing the diffraction light with the area extending in the radial direction where the optical beam intensity can be easily ensured, the signal intensity (optical beam intensity) can be increased compared with the case of using the pattern shown in FIG. 10.

FIG. 12 shows patterns 324-5 and 324-6 (300 is added to the same reference numerals to discriminate from FIG. 2) are formed by eliminating a fixed rate (mainly the peripheral edge portion) of the area passing the ±1st-order diffraction light from the pattern shown in FIG. 11, so that a component that can be a noise can be eliminated. Therefore, compared with the case of using the pattern shown in FIG. 11, the input from the peripheral edge portion that can be a noise component can be decreased, and as a result, the signal-to-noise ratio is improved.

Of course, the fluctuation of the largeness (absolute value) of a focusing error signal can be substantially cancelled by using the pattern shown in FIG. 11 or FIG. 12.

As explained hereinbefore, by generating a signal for detecting a focusing error by an optical spot divided by an optical dividing pattern of this invention extending in at least the radial direction, it is possible to record information on an HD DVD specification optical disc and detect exactly the largeness of a focusing error when reproducing information. At the same time, the fluctuation of the largeness (absolute value) of a focusing error signal can be decreased. Further, by setting the pattern to optimum shape and size, the space of the light-receiving area of a photodetector can be reduced, and the largeness of a noise component to an output signal can be decreased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the embodiments described hereinbefore, the luminous flux dividing pattern of a hologram is an example, and not limited to this.

In the description, a hologram is explained as a type of dividing and deflecting a luminous flux, and explanation is given on an example of using only a part of the luminous flux of a reflected light from an optical disc for a focusing error signal. But, it is applicable also to a method of using one of 0th-order light and ±1st-order light without dividing the luminous flux.

Further, a knife edge method is explained as an example of the method of detecting a focus (obtaining a focusing error signal). Of course, an astigmatic aberration method using astigmatic aberration or a spot size method using a change in spot size may be used as a focus detecting method.

In the detailed explanation of the invention, embodiments are explained by taking an optical disc apparatus as an example. It is needless to say that the invention is applicable also to a moving picture camera using an optical disc as a recording medium, and portable audio equipment containing musical data.

What is claimed is:

1. An optical head unit comprising:
a condensing means for condensing light on a recording surface of a recording medium and for taking light reflected on the recording surface of the recording medium;
a dividing means for dividing the light reflected on the recording surface of the recording medium; and
an optical detecting means for receiving the reflected light divided by the dividing means;
wherein the dividing means is configured to divide the reflected light linearly along a radial direction of the recording medium.

2. The optical head unit according to claim 1, wherein the area dividable by the dividing means linearly along the radial direction of the recording medium has a fixed interval in the direction orthogonal to the radial direction, centering around a partition line parallel to the radial direction of the recording medium.

3. The optical head unit according to claim 1, wherein the signal divided by the dividing means and detected by the photodetector is used to generate a control signal for moving the condensing means in a direction orthogonal to a plane including the recording surface of the recording medium.

4. The optical head unit according to claim 2, wherein the signal divided by the dividing means and detected by the photodetector is used to generate a control signal for moving the condensing means in a direction orthogonal to a plane including the recording surface of the recording medium.

5. An optical head unit comprising:
an objective lens which condenses light from a light source on the recording surface of a recording medium;
an optical dividing element which divides light reflected on the recording surface of the recording medium into several portions, and gives at least one of the divided reflected light a fixed diffraction not influenced by a diffraction specific to the recording medium, and
a photodetector which receives the reflected light divided by the optical dividing element, and outputs a signal corresponding to the intensity of the light.

6. The optical head unit according to claim 5, -wherein an area which gives a fixed diffraction to the reflected light divided by the optical dividing element is provided at a position not influenced by a diffraction specific to the recording medium generated in a direction orthogonal to the radial direction of the recording medium.

7. The optical head unit according to claim 5, wherein the signal divided by the dividing means and detected by the photodetector is used to generate a control signal for moving the condensing means in a direction orthogonal to a plane including the recording surface of the recording medium.

8. The optical head unit according to claim 6, wherein the signal divided by the dividing means and detected by the photodetector is used to generate a control signal for moving the condensing means in a direction orthogonal to a plane including the recording surface of the recording medium.

9. An optical disc unit comprising:
an optical head unit which includes an objective lens which condenses light from a light source on the recording surface of a recording medium takes light reflected from the recoding surface of the recording medium; an optical dividing element which divides light reflected on the recording surface of the recording medium into several portions, and gives at least one of the divided reflected light a fixed diffraction not influenced by a diffraction specific to the recording medium; and a photodetector which receives the reflected light divided by the optical dividing element, and outputs a signal corresponding to the intensity of the light; and
a signal processing unit which processes an output of the photodetector to be usable at least for controlling the position of the objective lens or reproducing information recorded in the recording medium;
wherein the dividing means divides the reflected light, so that the output of the photodetector reaches a peak at a position where the amount of defocus becomes substantially 0 when the objective lens is moved in the direction orthogonal to a plane including the recording surface of the recording medium.
